(19) United States
(12) Patent Application Publication
(10) Pub. No.: US 2013/0155494 A1
(43) Pub. Date: Jun. 20, 2013

(54) Two-Dimensional Auto-Cloning Polarizing Beam Splitter

(71) Applicants: Sheng-Hui Chen, Taoyuan County (TW); Cheng-Chung Lee, Taoyuan County (TW); Chao-Chun Huang, Taoyuan County (TW)

(72) Inventors: Sheng-Hui Chen, Taoyuan County (TW); Cheng-Chung Lee, Taoyuan County (TW); Chao-Chun Huang, Taoyuan County (TW)

(73) Assignee: Chung-Shan Institute of Science and Technology, Armaments, Bureau, Ministry of National Defense, Taoyuan County (TW)

(21) Appl. No.: 13/329,325

(22) Filed: Dec. 18, 2011

(51) Int. Cl. G02B 5/30

(52) U.S. Cl. 359/352; 359/485.03

(57) ABSTRACT

Disclosed is a miniature, two-dimensional, auto-cloning, polarizing beam splitter that includes a substrate and an optical multilayer. The substrate is formed with a periodic structure. The optical multilayer is formed on the periodic structure of the substrate. The optical multilayer includes a (LH)ⁿ structure wherein H represents a film of a high refractive index, and L represents a film of a low refractive index, and n is an integer. The auto-cloning polarizing beam splitter is operable to split infrared light of wavelengths of 1000 nm to 1300 nm.

### BACKGROUND OF INVENTION

1. Field of Invention

The present invention relates to a two-dimensional auto-cloning polarizing beam splitter and, more particularly, to a miniature, planar, auto-cloning, polarizing beam splitter.

2. Related Prior Art

A polarizing beam splitter is used to split incident light by reflecting a portion the incident light and passing another portion of the incident light because the portions of the incident light are polarized in different directions. The reflected portion of the incident light is called the S-polarized (or “TE-polarized”) light which exhibits an electric field extending perpendicular to the incident face. The passed portion of the incident light is called the P-polarized (or “TM-polarized”) light which exhibits an electric field extending parallel to the incident face. When the S-polarized light reaches and gets reflected from the polarizing beam splitter, the direction of the travel of the S-polarized light is changed. When the P-polarized light reaches and passes the polarizing beam splitter, the direction of the travel of the P-polarized light is retained. Thus, the incident light is split by the polarizing beam splitter.

A conventional polarizing beam splitter includes an uncoated prism, a coated prism and a cured adhesive layer. The -cured adhesive layer is used to bond the uncoated prism to the coated prism. The conventional polarizing beam splitter is however bulky. To produce a miniature, planar, polarizing beam splitter, an auto-cloning polarizing beam splitter is devised according to photonic crystal beam-splitting technique.

Regarding the photonic crystal beam-splitting technique, a concept of photonic band gap was first advocated by Professor Eli Yablonovitch in the UCLA and Professor Sajeev John in CANADA in the year of 1987. A photonic crystal includes a structure of periodic distribution of different refractive index materials. As light reaches the photonic crystal, some electromagnetic waves of certain wavelengths pass the photonic crystal while some other electromagnetic waves do not pass the photonic crystal but gets reflected from the photonic crystal. Thus, the light is split.

An auto-cloning technique is important for making a multi-dimensional photonic crystal. In the auto-cloning technique, thin films of high refractive index and low refractive index are alternately coated on a substrate with a periodic structure to form a zigzag structure. In the auto-cloning technique, a two-dimensional photonic crystal is made from one-dimensional photonic crystal.

Hence, there is a need for a two-dimensional auto-cloning technique for making a two-dimensional, auto-cloning, polarizing beam splitter that is miniature in comparison with a conventional polarizing beam splitter. Hence, the application such as an ellipseometer that includes such a two-dimensional, auto-cloning, polarizing beam splitter is structurally simple and miniature.

The present invention is therefore intended to obviate or at least alleviate the problems encountered in prior art.

### SUMMARY OF INVENTION

It is the primary objective of the present invention to provide a miniature, two-dimensional, auto-cloning, polarizing beam splitter.

To achieve the foregoing objectives, in a first embodiment, the two-dimensional, auto-cloning, polarizing beam splitter includes a substrate and an optical multilayer. The substrate is formed with a periodic structure. The optical multilayer is formed on the periodic structure of the substrate. The optical multilayer includes a (LH)ⁿ or (LH)ⁿL or (HL)ⁿ or (HL)ⁿH structure wherein H represents a film of a high refractive index, and L represents a film of a low refractive index, and n is the period which is an integer.

The two-dimensional, auto-cloning, polarizing beam splitter of the first embodiment is further operable to split infrared light of wavelengths of 860 nm to 940 nm and 1000 nm to 1300 nm.

In the first embodiment, the optical multilayer may include zigzag structures.

In the first embodiment, the zigzag structures may be made of a width-height ratio of 0.96:1.

In the first embodiment, the zigzag structures may extend in a roof angle.

In the first embodiment, the roof angle may be between 90 to 120 degrees.

In the first embodiment, the optical thickness of the low refractive index films may be about 1.5 times as thick as the optical thickness of the high refractive index films.

In a second embodiment, the two-dimensional auto-cloning polarizing beam splitter includes a substrate and an optical multilayer. The substrate is formed with a periodic structure. The optical multilayer is formed on the periodic structure of the substrate. The optical multilayer includes an L_{0.5}H(LH)ⁿL_{0.5} structure, wherein H represents a film of a high refractive index, and L represents a film of a low refractive index, and L_{0.5} represents a reduced film of a low refractive index about half as thick as the films of the low refractive index, and n is the period which is an integer.

The two-dimensional, auto-cloning, polarizing beam splitter of the second embodiment is operable to split infrared light of wavelengths of 860 nm to 940 nm and 1000 nm to 1300 nm.

In the second embodiment, the optical multilayer may include zigzag structures.

In the second embodiment, the zigzag structures may be made of a width-height ratio of 0.96:1.

In the second embodiment, the optical thickness of the low refractive index films may be about 1.5 times as thick as the optical thickness of the high refractive index films.

In a third embodiment, the two-dimensional auto-cloning polarizing beam splitter includes a substrate and an optical multilayer. The substrate is formed with a periodic structure. The optical multilayer formed on the periodic structure of the substrate, wherein the optical multilayer includes an H_{0.5}L(HL)ⁿH_{0.5} structure, wherein L represents a film of a low refractive index, and H represents a film of a high refractive index, and H_{0.5} represents a reduced film of a high refractive index about half as thick as the films of the high refractive index, and n is the period which is an integer.

The two-dimensional auto-cloning polarizing beam splitter of the third embodiment is operable to split infrared light of wavelengths of 1000 nm to 1300 nm.

In the third embodiment, the optical multilayer may include zigzag structures.

In the third embodiment, the zigzag structures may be made of a width-height ratio of 0.96:1.

In the third embodiment, the optical thickness of the low refractive index films may be about 1.5 times as thick as the optical thickness of the high refractive index films.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a two-dimensional auto-cloning polarizing beam splitter according to the first embodiment of the present invention;

FIG. 2 is a front view of the two-dimensional auto-cloning polarizing beam splitter shown in FIG. 1;

FIG. 3 is a front view of a peak of an LH pair of the two-dimensional auto-cloning polarizing beam splitter shown in FIG. 1;

FIG. 4 shows a spectrum of TE-polarized light and TM-polarized light processed by the two-dimensional auto-cloning polarizing beam splitter shown in FIG. 1;

FIG. 5 is a front view of a two-dimensional auto-cloning polarizing beam splitter according to the second embodiment of the present invention;

FIG. 6 shows a spectrum of TE-polarized light and TM-polarized light processed by the two-dimensional auto-cloning polarizing beam splitter shown in FIG. 5;

FIG. 7 is a front view of a two-dimensional auto-cloning polarizing beam splitter according to the third embodiment of the present invention; and

FIG. 8 shows a spectrum of TE-polarized light and TM-polarized light processed by the two-dimensional auto-cloning polarizing beam splitter shown in FIG. 7.

### DETAILED DESCRIPTION OF EMBODIMENTS

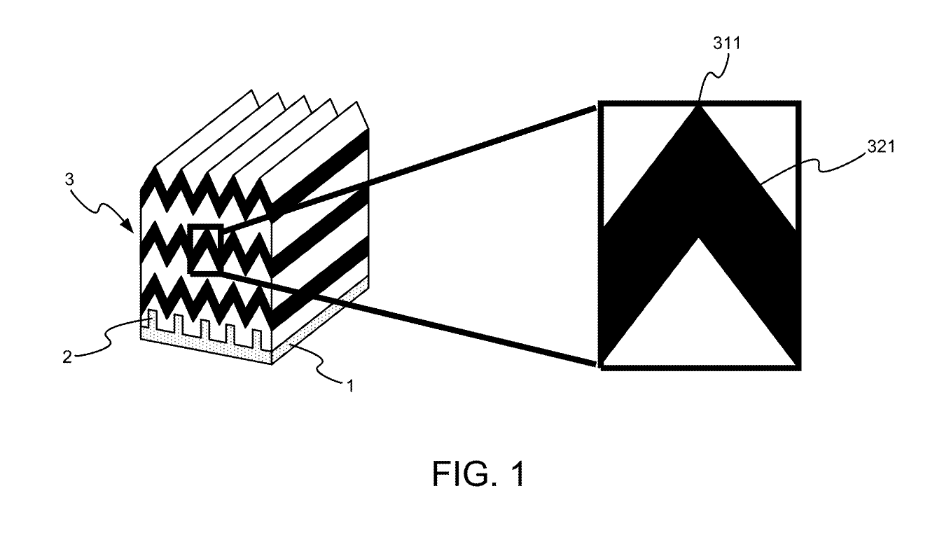

Referring to FIGS. 1 through 3, shown is a two-dimensional auto-cloning polarizing beam splitter according to a first embodiment of the present invention. The two-dimensional, auto-cloning, polarizing beam splitter is based on an anisotropic property of a two-dimensional, photonic crystal. For incident light in the operative range of the two-dimensional, auto-cloning, polarizing beam splitter, TE-polarized (or “S-polarized”) light thereof is in a stop band while TM-polarized (or “P-polarized”) light thereof is in a pass band. As the incident light reaches the polarizing beam splitter, the TE-polarized light gets reflected from the polarizing beam splitter while the TM-polarized light passes the polarizing beam splitter. Thus, the incident light is split.

Referring to FIG. 1, the two-dimensional, auto-cloning, polarizing beam splitter includes a two-dimensional, photonic crystal made by an auto-cloning technique. In the auto-cloning technique, a lithography and dry etching methods are used to form a periodic pattern on a substrate 1, and radio frequency (“RF”) sputtering is used to coat the substrate 1 with dielectric films with an RF bias. The dielectric films are made of different thicknesses but all extend in zigzag structures. A two-dimensional photonic crystal is made. The two-dimensional photonic crystal includes a stop band and a pass band for polarizing beam-splitting. The zigzag-like periodic structure of the dielectric films is a repeating of a basic structure. The height and width of the basic structure determine the optical properties of the auto-cloning polarizing beam splitter.

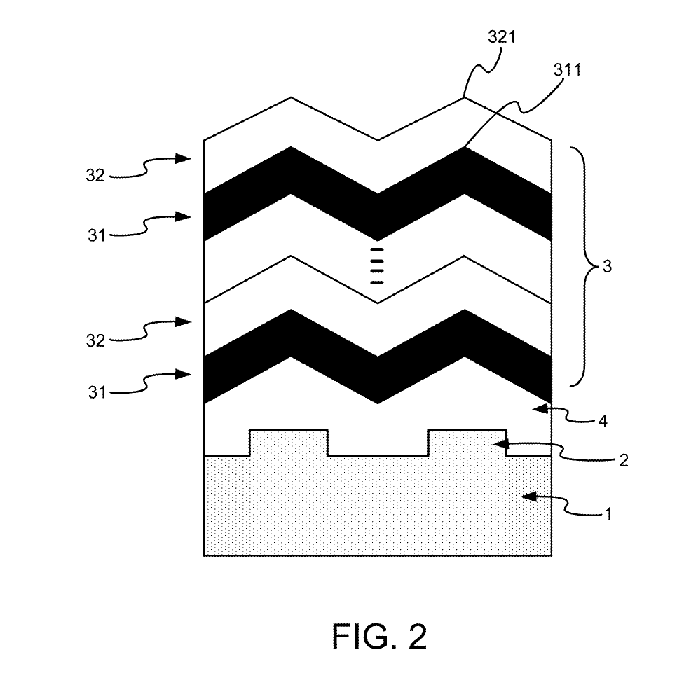

Referring to FIG. 2, the two-dimensional, auto-cloning, polarizing beam-splitter includes an optical multilayer 3 provided on a substrate 1. The substrate 1 may be a silicon-based substrate 1 for example. A periodic line width is defined on the substrate 1 by photoresist and lithography while a periodic depth is defined by reactive ion etching. A periodic configuration 2 is thus formed on the substrate 1.

The optical multilayer 3 includes films 31 of a high refractive index and films 32 of a low refractive index. The films 31 of the high refractive index and the films 32 of the low refractive index are arranged alternately. Each of the films 31 of the high refractive index is formed with zigzag structures 311. For example, the films 31 of the high refractive index may be TiO₂ films of 250 nm thick. Each of the films 32 of the low refractive index is formed with zigzag structures 321. For example, the films 32 of the low refractive index may be SiO₂ films of 375 nm thick. The films 32 of the low refractive index are about 1.5 times as thick as the films 31 of the high refractive index.

The structure of the optical multilayer 3 is (LH)ⁿ wherein H represents a film 31 of the high refractive index made of TiO₂ for example, and L represents a film 32 of the low refractive index made of SiO₂ for example, and n is an integer used to represent the amount of the LH pairs. When n is 10 for example, there are ten layers 31 of the high refractive index made of TiO₂ for example and ten layers 32 of low refractive index made of SiO₂ for example, i.e., there are twenty layers totally. In the (LH)¹⁰ structure of the optical multilayer 3, each of the films 32 of the low refractive index is provided on a respective one of the films 31 of the high refractive index. That is, in each LH pair, the film 32 of the low refractive index is located higher than the film 31 of the high refractive index.

In the first embodiment, there is preferably at least one shaping layer 4 in the optical multilayer 3. The shaping layer 4 is used as a bone for keeping the optical multilayer 3 in shape. The shaping layer 4 extends in a wave-like manner. Thus, the optical multilayer 3 is retained in the zigzag structures by the shaping layer 4.

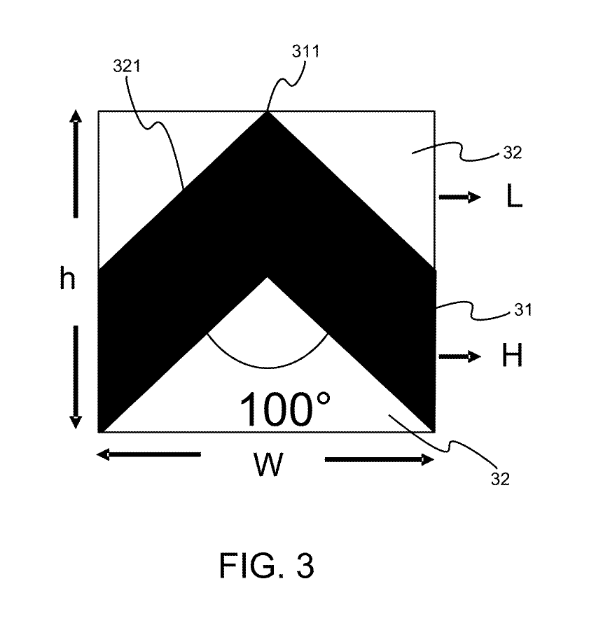

Referring to FIG. 3, one of the zigzag structures 311 and a respective one of the zigzag structures 321 are shown. The angle of the zigzag structures 311 and 321 is a roof angle such as 90 to 120 degrees. Where the angle is 100 degrees, the ratio of the thickness of the films 31 of the high refractive index over the thickness of the films 32 of the low refractive index is about 1:1.5. Where the ratio of the width over the height is 0.96:1 in the zigzag structures 311 and 321, the auto-cloning polarizing beam splitter is operable to split infrared light of wavelengths of 1000 nm to 1300 nm.

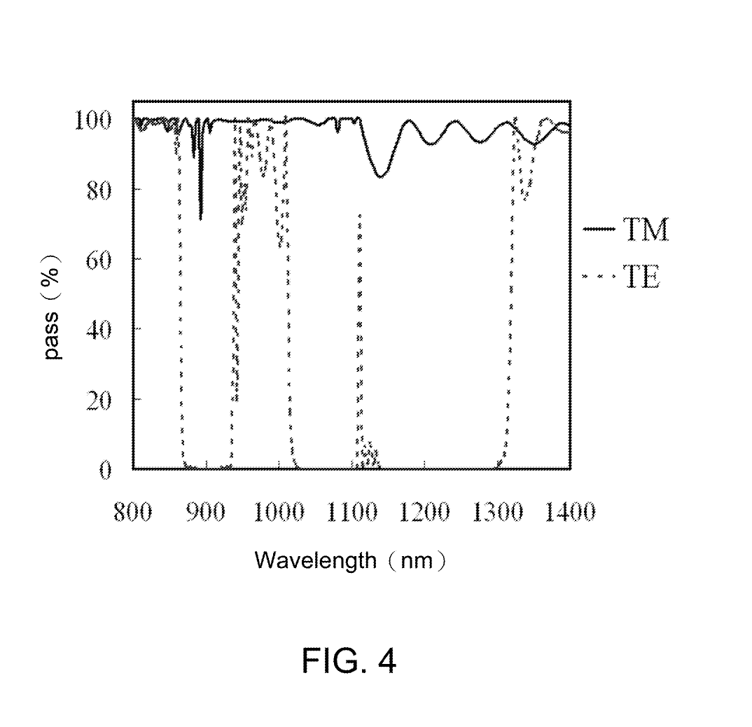

Referring to FIG. 4, there is shown a spectrum of the TE-polarized light and the TM-polarized light of the light processed by the two-dimensional auto-cloning polarizing beam splitter. The auto-cloning polarizing beam splitter is used to process infrared light of wavelengths of 1000 nm to 1300 nm. About 90% of the TM-polarized light passes the two-dimensional auto-cloning polarizing beam splitter. None of the TE-polarized light passes the two-dimensional auto-cloning polarizing beam splitter. For infrared light of wavelengths of 860 nm to 940 nm, the two-dimensional auto-cloning polarizing beam splitter achieves similar results for the TM-polarized light and the TE-polarized light. The two-dimensional auto-cloning polarizing beam splitter can be used to split not only the infrared light of wavelengths of 1000 nm to 1300 nm but also the infrared light of wavelengths of 860 nm to 940 nm.

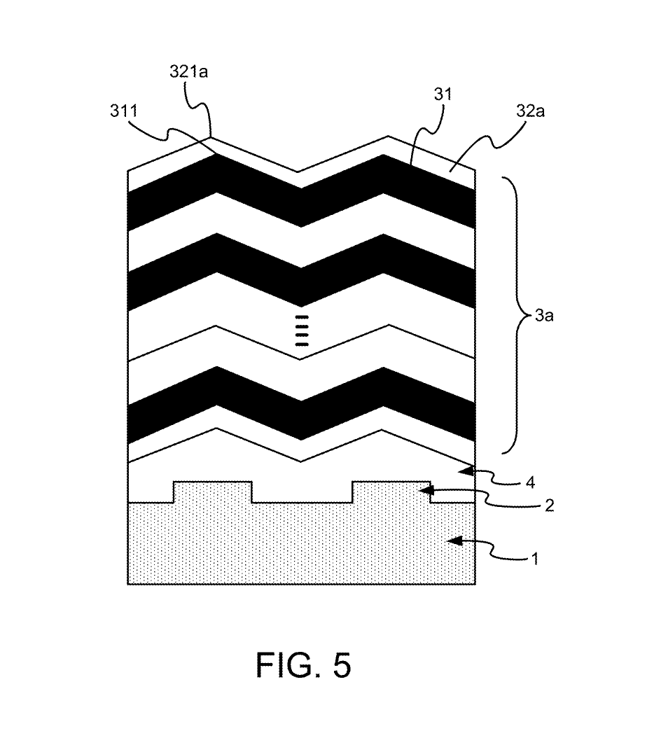

Referring to FIG. 5, there is shown a two-dimensional, auto-cloning, polarizing beam splitter according to a second embodiment of the present invention. The two-dimensional, auto-cloning, polarizing beam-splitter of the second embodiment also includes an optical multilayer 3a provided on a substrate 1. The substrate 1 may be a silicon-based substrate for example. A periodic line width is defined on the substrate 1 by photoresist and lithography while a periodic depth is defined by reactive ion etching. A periodic configuration 2 is thus formed on the substrate 1.

The optical multilayer 3a includes films 31 of a high refractive index and films 32 of a low refractive index. The films 31 of the high refractive index and the films 32 of the low refractive index are arranged alternately. Each of the films 31 of the high refractive index is formed with zigzag structures 311. For example, the films 31 of the high refractive index may be TiO₂ films of 250 nm thick. Each of the films 32 of the low refractive index is formed with zigzag structures 321. For example, the films 32 of the low refractive index may be SiO₂ films of 375 nm thick. The films 32 of the low refractive index are about 1.5 times as thick as the films 31 of the high refractive index.

The structure of the optical multilayer 3a is L_{0.5}H(LH)ⁿL_{0.5} wherein H represents a film 31 of the high refractive index made of TiO₂ for example, and L represents a film 32 of the low refractive index made of SiO₂ for example, and L_{0.5} represents a reduced film 32a of the low refractive index half as thick as the films 32 of the low refractive index, and n is an integer used to represent the number of the LH pairs. For example, when n is 10, there are 10 LH pairs. The L_{0.5}H(LH)ⁿL_{0.5} structure of the optical multilayer 3a includes, from top to bottom, a reduced film 32a of the low refractive index, a layer 31 of the high refractive index, the LH pairs and another reduced film 32a of the low refractive index. Each of the reduced films 32a of the low refractive index is formed with zigzag structures 321a.

In the second embodiment, there is preferably at least one shaping layer 4 in the optical multilayer 3a. The shaping layer 4 is used as a bone for keeping the optical multilayer 3a in shape. The shaping layer 4 extends in a zigzag-like structure. Thus, the optical multilayer 3a is retained in the zigzag-like structure by the shaping layer 4.

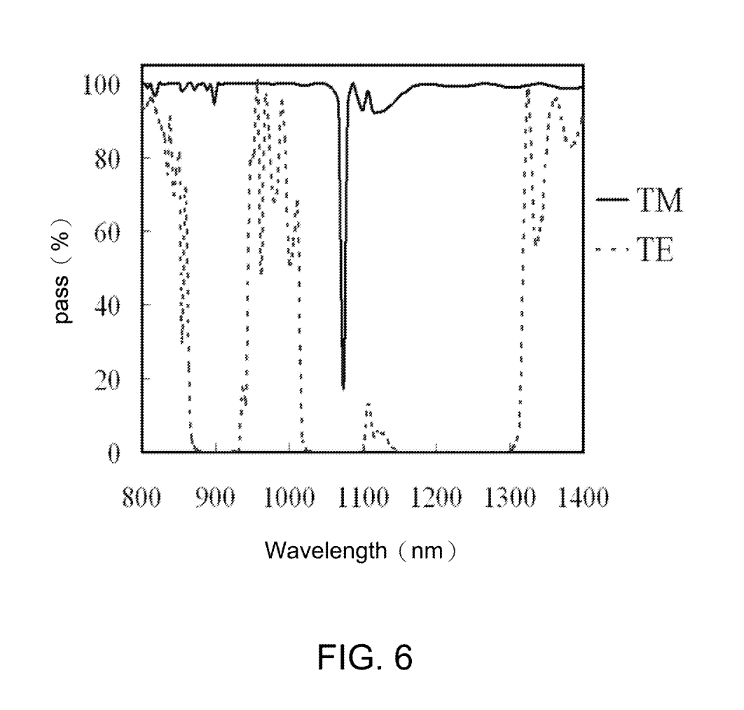

Referring to FIG. 6, there is shown a spectrum of the TE-polarized light and the TM-polarized light of the light processed by the two-dimensional auto-cloning polarizing beam splitter of the second embodiment of the present invention. The auto-cloning polarizing beam splitter is used to process infrared light of wavelengths of 1000 nm to 1300 nm. About 95% of the TM-polarized light passes the two-dimensional auto-cloning polarizing beam splitter. None of the TE-polarized light passes the two-dimensional auto-cloning polarizing beam splitter. For infrared light of wavelengths of 860 nm to 940 nm, the two-dimensional auto-cloning polarizing beam splitter achieves similar results for the TM-polarized light and the TE-polarized light. The two-dimensional auto-cloning polarizing beam splitter can be used to split not only the infrared light of wavelengths of 1000 nm to 1300 nm but also the infrared light of wavelengths of 860 nm to 940 nm.

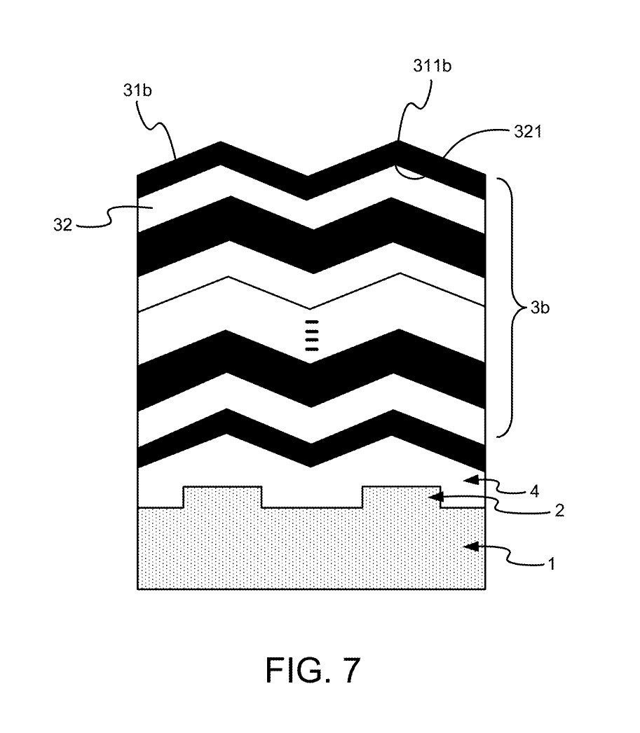

Referring to FIG. 7, there is shown a two-dimensional, auto-cloning, polarizing beam splitter according to a third embodiment of the present invention. The two-dimensional, auto-cloning, polarizing beam-splitter of the third embodiment also includes an optical multilayer 3b provided on a substrate 1. The substrate 1 may be a silicon-based substrate for example. A periodic line width is defined on the substrate 1 by photo-resist and lithography while a periodic depth is defined by reactive ion etching. A periodic configuration 2 is thus formed on the substrate 1.

The optical multilayer 3b includes films 31 of a high refractive index and films 32 of a low refractive index. The films 31 of the high refractive index and the films 32 of the low refractive index are arranged alternately. Each of the films 31 of the high refractive index is formed with zigzag structures 311. For example, the films 31 of the high refractive index may be TiO₂ films of 250 nm thick. Each of the films 32 of the low refractive index is formed with zigzag structures 321. For example, the films 32 of the low refractive index may be SiO₂ films of 375 nm thick. The films 32 of the low refractive index are about 1.5 times as thick as the films 31 of the high refractive index.

The structure of the optical multilayer 3b is H_{0.5}L(HL)ⁿH_{0.5} wherein L represents a film 32 of the low refractive index made of SiO₂ for example, and H represents a film 31 of the high refractive index made of TiO₂ for example, and H_{0.5} represents a reduced film 31b of the high refractive index half as thick as the films 31 of the high refractive index, and n is an integer used to represent the number of the HL pairs. For example, when n is 10, there are 10 HL pairs. The H_{0.5}L(HL)ⁿH_{0.5} structure of the optical multilayer 3b includes, from top to bottom, a reduced film 31b of the high refractive index, a layer 32 of the low refractive index, the HL pairs and another reduced film 31b of the high refractive index. Each of the reduced films 31b of the high refractive index is formed with zigzag structures 311b.

In the third embodiment, there is preferably at least one shaping layer 4 in the optical multilayer 3b. The shaping layer 4 is used as a bone for keeping the optical multilayer 3b in shape. The shaping layer 4 extends in a zigzag-like structure. Thus, the optical multilayer 3b is retained in the zigzag-like structure by the shaping layer 4.

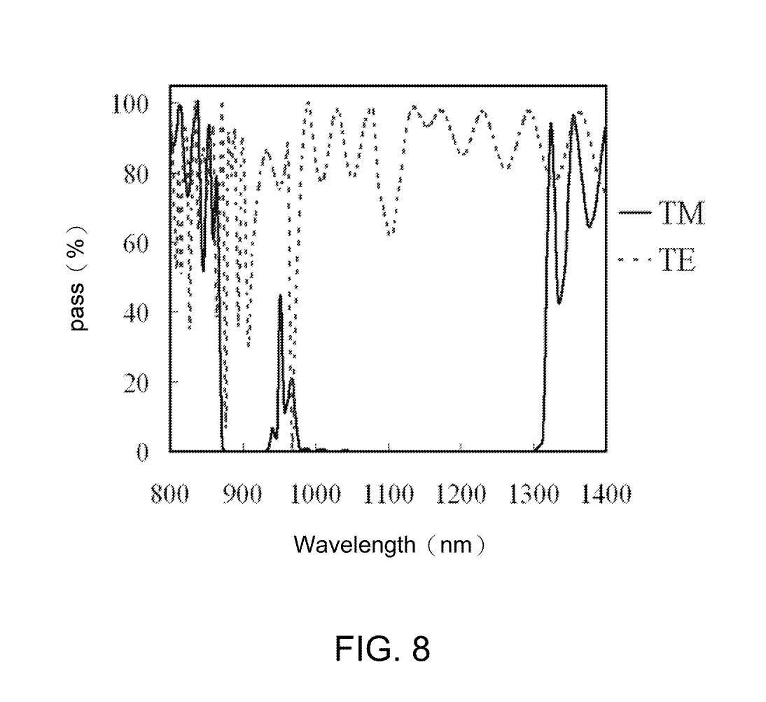

Referring to FIG. 8, there is shown a spectrum of the TE-polarized light and the TM-polarized light of the light processed by the two-dimensional auto-cloning polarizing beam splitter of the second embodiment of the present invention. The auto-cloning polarizing beam splitter is used to process infrared light of wavelengths of 1000 nm to 1300 nm. About 85% of the TM-polarized light passes the two-dimensional auto-cloning polarizing beam splitter. None of the TE-polarized light passes the two-dimensional auto-cloning polarizing beam splitter.

As described above, the self-cloning technique is used to make the two-dimensional, auto-cloning, polarizing beam splitter of the present invention that is miniature in comparison with conventional beam splitters. Thus, an ellipseometer equipped with the two-dimensional, auto-cloning, polarizing beam splitter of the present invention is miniature.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A two-dimensional, auto-cloning, polarizing beam splitter including:
a substrate formed with a periodic structure; and
an optical multilayer formed on the periodic structure of the substrate, wherein the optical multilayer includes a (LH)ⁿ structure wherein H represents a film of a high refractive index, and L represents a film of a low refractive index, and n is an integer, wherein the auto-cloning polarizing beam splitter is operable to split infrared light of wavelengths of 1000 nm to 1300 nm.

2. The two-dimensional auto-cloning polarizing beam splitter according to claim 1, wherein the two-dimensional auto-cloning polarizing beam splitter is further operable to split infrared light of wavelengths of 860 nm to 940 nm.

3. The two-dimensional auto-cloning polarizing beam splitter according to claim 1, wherein the optical multilayer includes a zigzag-like configuration formed with zigzag structures.

4. The two-dimensional auto-cloning polarizing beam splitter according to claim 3, wherein the zigzag structures are made of a width-height ratio of 0.96:1.

5. The two-dimensional auto-cloning polarizing beam splitter according to claim 3, wherein the zigzag structures extend in a roof angle.

6. The two-dimensional auto-cloning polarizing beam splitter according to claim 5, wherein the roof angle is 90 to 120 degrees.

7. The two-dimensional auto-cloning polarizing beam splitter according to claim 1, wherein the films of the low refractive index are about 1.5 times as thick as the films of the high refractive index.

8. A two-dimensional auto-cloning polarizing beam splitter including:
a substrate formed with a periodic structure; and
an optical multilayer formed on the periodic structure of the substrate, wherein the optical multilayer includes an L_{0.5}H(LH)ⁿL_{0.5} structure, wherein H represents a film of a high refractive index, and L represents a film of a low refractive index, and L_{0.5} represents a reduced film of a low refractive index about half as thick as the films of the low refractive index, and n is an integer.

9. The two-dimensional auto-cloning polarizing beam splitter according to claim 8, wherein the auto-cloning polarizing beam splitter is operable to split infrared light of wavelengths of 1000 nm to 1300 nm.

10. The two-dimensional auto-cloning polarizing beam splitter according to claim 8, wherein the two-dimensional auto-cloning polarizing beam splitter is operable to split infrared light of wavelengths of 860 nm to 940 nm.

11. The two-dimensional auto-cloning polarizing beam splitter according to claim 8, wherein the optical multilayer includes a zigzag-like configuration formed with zigzag structures.

12. The two-dimensional auto-cloning polarizing beam splitter according to claim 11, wherein the zigzag structures are made of a width-height ratio of 0.96:1.

13. The two-dimensional auto-cloning polarizing beam splitter according to claim 8, wherein the films of the low refractive index are about 1.5 times as thick as the films of the high refractive index.

14. A two-dimensional auto-cloning polarizing beam splitter including:
a substrate formed with a periodic structure; and
an optical multilayer formed on the periodic structure of the substrate, wherein the optical multilayer includes an H_{0.5}L(HL)ⁿH_{0.5} structure, wherein L represents a film of a low refractive index, and H represents a film of a high refractive index, and H_{0.5} represents a reduced film of a high refractive index about half as thick as the films of the high refractive index, and n is an integer.

15. The two-dimensional auto-cloning polarizing beam splitter according to claim 14, wherein the two-dimensional auto-cloning polarizing beam splitter is operable to split infrared light of wavelengths of 1000 nm to 1300 nm.

16. The two-dimensional auto-cloning polarizing beam splitter according to claim 14, wherein the optical multilayer includes a zigzag-like configuration formed with zigzag structures.

17. The two-dimensional auto-cloning polarizing beam splitter according to claim 16, wherein the zigzag structures are made of a width-height ratio of 0.96:1.

18. The two-dimensional auto-cloning polarizing beam splitter according to claim 16, wherein the films of the low refractive index are about 1.5 times as thick as the films of the high refractive index.
